(19) United States
(12) Patent Application Publication
(10) Pub. No.: US 2015/0104718 A1
(43) Pub. Date: Apr. 16, 2015

(54) FLEXIBLE TRANSPARENT AIR-METAL BATTERIES

(71) Applicant: Christopher J. Rothfuss, (US)

(72) Inventor: Sung-Wei Chen, Las Vegas, NV (US)

(73) Assignee: EMPIRE TECHNOLOGY DEVELOPMENT LLC, Wilmington, DE (US)

(21) Appl. No.: 13/879,863

(22) PCT Filed: Aug. 14, 2012
(86) PCT No.: PCT/US12/50735

§ 371 Date: Dec. 6, 2014

(51) Int. Cl. H01M 12/06

(52) U.S. Cl. CPC H01M 12/06
USPC 429/403; 29/623.1

(57) ABSTRACT

A flexible air-metal battery is described. The battery may include a flexible oxygen permeable substrate, an air cathode that is in contact with the substrate, a flexible electrolyte in electrical contact with the air cathode, a flexible metal anode in contact with the flexible electrolyte such that the flexible metal anode is not in contact with the air cathode, and a plurality of flexible current collectors. At least one of the current collectors is in contact with the air cathode and at least one of the flexible current collectors is in contact with the metal anode.

### BACKGROUND

Batteries are energy storage devices that store energy in the form of chemical energy that can be converted into electrical energy. There are two types of batteries (a) primary batteries, which are disposable and may be used once, and (b) secondary batteries, which are rechargeable and may be used multiple times. Batteries are available in many sizes from miniature cells used for powering small low power devices such as watches to room-sized battery banks for providing standby power to, for example, computer data centers, or store energy generated by renewable energy sources such as wind and solar.

A battery may contain a number of voltaic cells, each voltaic cell consisting of two half-cells connected in series by a conductive electrolyte containing anions and cations. A half-cell includes an electrode to which ions migrate and an electrolyte. The electrolyte for the two half-cells may be the same or different depending on the chemistry of the voltaic cell. Similarly, the voltage that a cell can produce depends on the chemistry of the cell. Various materials may be used for the electrodes and the electrolytes.

Value of a certain battery chemistry may be determined by the energy density or specific energy (measured in kJ/g) available for that chemistry. Most of the battery research is focused in reducing the cost of manufacturing for batteries with high density chemistry while maintaining the safety and portability. As portability of electronics is increased, there remains a need for high density, flexible battery technology.

### SUMMARY

In one embodiment, a flexible air-metal battery may include a flexible oxygen permeable substrate, an air cathode that is in contact with the substrate, a flexible electrolyte in electrical contact with the air cathode, a flexible metal anode in contact with the flexible electrolyte such that the flexible metal anode is not in contact with the air cathode, and a plurality of flexible current collectors. At least one of the current collectors is in contact with the air cathode and at least one of the flexible current collectors is in contact with the metal anode.

In one embodiment, a method of making a flexible battery may include providing a flexible oxygen permeable substrate, providing an air cathode, providing a metal anode, providing a plurality of flexible current collectors and stacking in order, the oxygen permeable substrate, the electrolyte, the air cathode, the metal anode and the current collectors to form the battery.

### BRIEF DESCRIPTION OF FIGURES

FIG. 1 shows an illustrative schematic of a flexible air metal battery according to an embodiment.

FIG. 2 shows a flow chart for an illustrative method of making a flexible battery according to an embodiment.

FIG. 3 shows an illustrative schematic of a flexible air-metal battery according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

This disclosure describes flexible air metal batteries, and method of making such batteries. Flexible air metal batteries include an air cathode with a suitable catalyst, a flexible electrolyte, and a flexible metal anode. Embodiments herein describe various chemistries that may be used for air metal batteries. Other useful chemistries will be apparent to those of ordinary skill in the art based on the teachings of this disclosure. Flexible batteries may be used to power portable electronics or store energy produced by renewable sources. Other uses will be apparent to those of ordinary skill in the art.

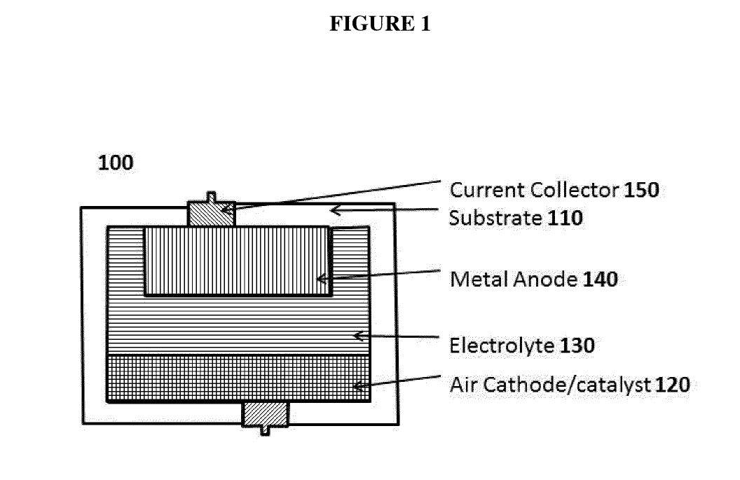

FIG. 1 shows an illustrative schematic of a flexible air metal battery according to an embodiment. In some embodiments, a flexible air metal battery 100 may include a flexible oxygen permeable substrate 110, an air cathode 120 that is in contact with the substrate, a flexible electrolyte 130 in electrical contact with the air cathode, a flexible metal anode 140 in contact with the flexible electrolyte and not in contact with the air cathode, and a plurality of flexible current collectors 150. At least one of the current collectors is in contact with the air cathode 120 and at least one of the flexible current collectors is in contact with the metal anode 140.

In some applications such as, for example, powering transparent display devices, it may be desirable for the battery 100 to be transparent. In some embodiments, one or more of the substrate 110, the electrolyte 130, the cathode 120, the anode 140, and the current collectors 150 may be optically transparent.

In some embodiments, the substrate 110 may be made from, for example, polyorganosiloxanes, polysulfones, polymer foams, silicone rubbers, cellulose acetates, polydimethylsiloxane, or a combination thereof. Some polymers are inherently oxygen permeable and thus, more amenable for use as an oxygen permeable flexible substrate. Polymers that are not inherently oxygen permeable may be made porous in order for air (or oxygen) to permeate through a substrate formed using such polymers. In some embodiments, the substrate 110 may have pores of about 50 μm to about 500 μm in diameter. Exemplary pore diameters include 50 μm, 60 μm, 70 μm, 80 μm, 90 μm, 100 μm, 150 μm, 200 μm, 250 μm, 300 μm, 350 μm, 400 μm, 450 μm, 500 μm, or any range between any two of these numbers. It will be understood that all the pores in a porous material may not be of the same size and that there may be a range of pore sizes. The exemplary pore sizes, therefore, should be considered as examples of the average pore size. One of ordinary skill in the art will be able to choose an optimal pore size by considering factors such as, for example, the strength of the substrate desired for the specific application of the resulting battery 100, the specific oxygen permeability of the material, economy of fabricating the porous substrate with the particular pore size, and/or the like.

In some embodiments, the air cathode 120 may include a carbon and a metal oxide catalyst. In some embodiments, the metal oxide catalyst may be an oxide of one or more of manganese, cobalt, ruthenium, platinum, silver, a mixture of manganese and cobalt, and/or a combination thereof. In some embodiments, the carbon comprises one or more of mesoporous carbon, activated charcoal, carbon black, Super P, powdered graphite, and graphene. In embodiments such as, for example, when powering a display device, it may be desirable that the air cathode 120 be transparent. In such embodiments, the air cathode 120 may be made as a wire-grid with an average diameter of less than or equal to about 50 μm. In embodiments wherein transparency is desired and the air cathode 120 includes a carbon and a metal-oxide catalyst, the air cathode may be made as a wire-grid with an average diameter of less than about 25 μm and a half-pitch of at least about 50 μm. One of ordinary skill in the art will obtain guidance from factors such as, for example, compatibility with other materials being used in the battery 100, compatibility with other materials used in the particular application where the resulting battery 100 will be used, cost of materials, catalytic activity, current capacity of the resulting battery desired for the particular application, charging and/or discharging times of the resulting battery desired for the particular application, and/or the like.

In some embodiments, the metal anode 140 may be, for example, lithium, sodium, potassium, beryllium, magnesium, calcium, aluminum, zinc, iron, titanium, alloys thereof, or a combination thereof. In embodiments wherein transparency is desired, the metal anode 140 may be made as a wire-grid having wires of the metal such that the wires have an average diameter of equal to or less than about 50 μm separated by a half-pitch of at least about 50 μm. One of ordinary skill in the art will appreciate that different metals have different energy densities and the specific choice of the metal would depend on the particular application for the resulting battery 100. Factors such as, for example, compatibility with other materials used in the particular application, cost of materials, cost of fabrication of the materials in a shape suitable for the particular application, and so forth, may provide guidance to a skilled artisan in choosing an appropriate material for the anode 140.

In some embodiments, the electrolyte 130 may be a salt having ions of a metal of the metal anode 140. For example, if the metal anode 140 is lithium, the electrolyte 130 may be a lithium salt. In some embodiments, the electrolyte 130 may be a polymer gel including a solvent, and a lithium imide salt such as, for example, lithium bis(trifluoromethansulfonyl)imide, poly(vinylidene-co-hexafluoropropylene), 1-methyl-3-propylpyrrolidinium bis(trifluoromethansulfonyl)imide, or a combination thereof. In some embodiments, the solvent may be, for example, ethylene carbonate, propylene carbonate, dimethyl carbonate, dioxolane, tetrahydrofuran, γ-butyrolactone, and/or the like. In some embodiments, the electrolyte may contain lithium salts such as, for example, LiPF₆, LiAsF₆, LiN(SO₂CF₃)₂, LiSO₃CF₃, or a combination thereof. It will be understood that the specific choice of electrolyte 130 will depend on other materials used in the battery 100 and more specifically, the metal used for metal anode 140. Other factors that may provide guidance to a skilled artisan in choosing the electrolyte 130 include, but are not limited to, flexibility of the electrolyte, stability of the electrolyte, material of the air cathode, conductivity of the electrolyte, other materials used in making the battery 100 such as, for example, a binder for the electrolyte, and/or the like.

In some embodiments, the current collector 150 may be a metal thin film. Examples of metals that may be used as current collectors 150 include, but are not limited to, aluminum, copper, silver, gold, platinum, chromium, nickel, brass, and/or the like. In some embodiments, the thin film may be deposited on at least a portion of the substrate 110 such that the film is separately in electrical contact with the air cathode 120 and the metal anode 140. In embodiments where transparency is desired, one skilled in the art will be able to choose suitable thickness of the thin film based on the specific metal being used for the current collector 150. In some embodiments, the current collector 150 may be a thin film of a transparent conducting metal-oxide such as, for example, fluorine doped tin oxide, indium doped tin oxide, aluminum doped zinc oxide, or a combination thereof. In some embodiments, the current collector 150 may be, for example a transparent conducting polymer such as, for example, poly(3,4-ethylenedioxythiophene), poly(4,4-dioctylcyclopentadithiophene), or a combination thereof. In some embodiments, the current collector 150 may include a conductive slurry. In some embodiments, the conductive slurry may be immobilized on the substrate. It will be understood that the current collector 150 may be used to establish an electrical contact between the cathode 120 or the anode 140 and the device that is being powered by the battery 100. As such, the current collectors 150 may be designed so that they do not provide a direct electrical path from the cathode 120 to the anode 140.

In some embodiments, the battery 100 may be used in environments having bad air quality such as, for example, high particulate content, high humidity, high concentration of reactive gases, and/or the like. In such embodiments, it may be desirable to filter the air reaching the air cathode 120 through the substrate. In some embodiments, the filter may be configured to remove, for example, water vapor, particles larger than a certain size, carbon monoxide, ozone, nitrogen oxides, sulfur oxides, ammonia, chlorofluorocarbons, methane, chlorine, volatile organic compounds, other reactive gases, or a combination thereof. Air filters configured to filter out specific matter are known in the art and one of ordinary skill will be able to choose an appropriate air filter depending on the specific matter that is required to be kept out of the battery.

In some embodiments, the battery 100 may be a primary battery and in alternate embodiments, the battery 100 may be a secondary battery. A skilled artisan will appreciate that the specific chemistry of the battery 100 will determine whether the battery is primary or secondary. Similarly, a skilled artisan will be able to choose a specific battery configuration based on the particular application that the battery is to be used for.

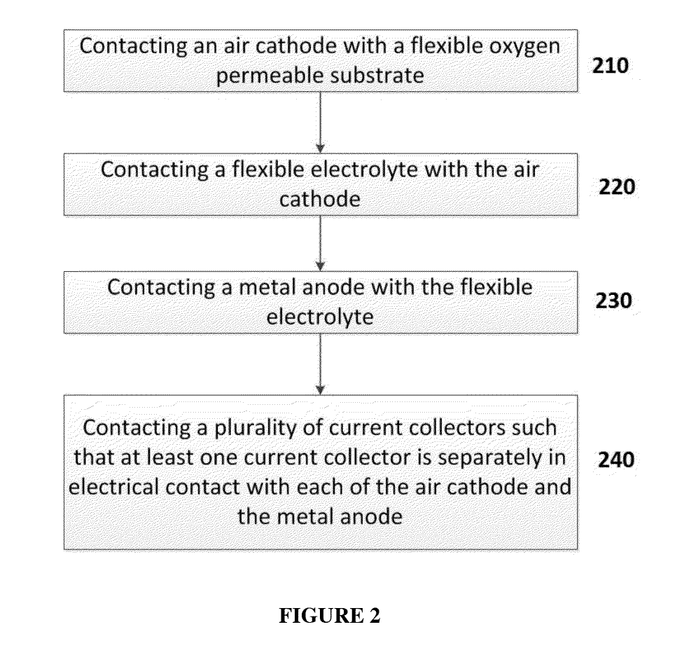

FIG. 2 shows a flow chart for an illustrative method of making a flexible battery according to an embodiment. In some embodiments, the method of making a flexible battery may include contacting 210 an air cathode with a flexible oxygen-permeable substrate, contacting 220 a flexible electrolyte with the air cathode, contacting 230 a metal anode with the flexible electrolyte, and contacting 240 a plurality of flexible current collectors, such that at least one current collector is separately in electrical contact with both the air cathode and the metal anode. Various embodiments for the flexible oxygen permeable substrate, the air cathode, the flexible electrolyte, the metal anode, and the current collectors are described herein.

In some embodiments, the method of making the battery may include stacking in order, the oxygen permeable substrate, a first flexible current collector, the air cathode, the electrolyte, the metal anode and a second flexible current collector. In some embodiments, the stacking may be such that the oxygen permeable substrate encapsulates the air cathode, the electrolyte and the metal anode. The first and second flexible current collectors are used for connecting the battery to the external circuit to which the battery is meant to provide power. It may be, therefore, desired in some embodiments that the current collectors are exposed outside of the substrate. In some embodiments, the first and the second flexible current collectors contact the air cathode and the metal anode such that at least a portion of the first and the second flexible current collectors is outside the oxygen permeable substrate.

In some embodiments, depending on the chemistry of the battery, the electrolyte may be an aqueous electrolyte. In such embodiments, it may be desirable to stack a porous separator between the aqueous electrolyte and the air cathode when contacting the electrolyte to the air cathode. In some embodiments, the electrolyte may be a solid state electrolyte. In such embodiments, it may be desirable to add a polymer ceramic between the air cathode and the electrolyte, and the electrolyte and the metal anode.

It is to be understood that specific configurations of the battery and the order or stacking the different layers of the battery are dependent on the specific choice of the chemistry of the battery. The chemistry of the battery is dependent on the choice of the metal anode, and the choice of the catalyst material at the air cathode. The catalyst works to exchange electrons from the electrolyte to the current collector at the cathode. One of ordinary skill in the art may envision various embodiments for flexible air-metal batteries.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

### EXAMPLES

### Example 1

### Aprotic Air-Metal Battery

A polydimethyl siloxane (PDMS) layer that is about 100 μm thick is used as the flexible oxygen permeable substrate. Lithium is used as the metal anode. As the electrolyte, an aprotic gel that is made of lithium bis(trufluoromethansulfonyl)imide (LiTFSI) and 1-methyl-3-propylpyrrolidinium bis (trifluoromethansulfonyl)imide (P13TFSI) mixed with poly(vinylidene-co-hexafluropropylene) and ethylene carbonate is used. A fine powder of carbon black dispersed with manganese oxide is used as the air cathode, and a gold thin film is used for the flexible current collector. FIG. 1 shows a battery constructed with this configuration. The components are stacked in the order shown in the figure to form the battery.

### Example 2

### Transparent Air-Metal Battery

The cathode and anode are made transparent by designing materials to be smaller than can be perceived by the human eye (50 μm). The cathode is made smaller than the anode so that reaction products that accumulate at the cathode do not increase the cathode size to where it may be perceived. A wire-grid with a wire diameter of about 45 μm and a half-pitch of about 50 μm is made from zinc to be used as anode and a wire-grid of carbon coated manganese oxide with a wire diameter of about 25 μm and a half pitch of about 50 μm is used as the catalyst at the cathode. Any suitable electrolyte with a zinc salt may be used as the electrolyte. The substrate is made from PDMS with fluorine-doped tin oxide thin film coated as current collectors at the anode and the cathode.

### Example 3

### Manufacturing a Zinc-Air Battery

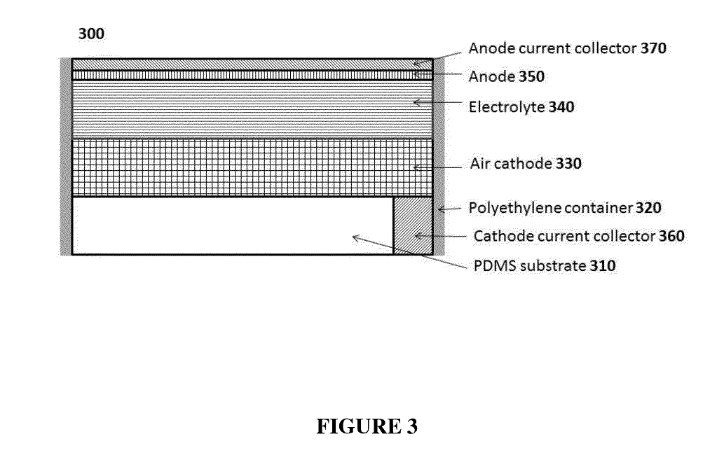

Referring to FIG. 3, a PDMS layer 310 of about 100 μm thick is placed in a hollow polyethylene roll 320 such that the PDMS layer forms the bottom of a cylinder. The PDMS layer forms the flexible oxygen permeable substrate. A nanoparticulate mixture of graphite and manganese dioxide 330 is placed on top of the PDMS layer to form the air cathode, and a potassium hydroxide paste 340 is added on top of the air cathode as the electrolyte. A thin zinc plate 350 is then place on top of the electrolyte as the metal anode. A small hole is made into the PDMS layer and a gold bead 360 is placed such that the bead is in contact with the air cathode 330, to form the cathode current collector. A thin gold layer 370 is deposited on top of the zinc plate 350 to form the anode current collector. The dimensions of the PDMS layer 310, the hollow polyethylene roll 320, and the zinc plate 350 are chosen such as to form a sealed container, to form the battery 300.

### Example 4

### Use of Zinc-Air Battery

A flexible zinc-air battery is integrated into a cover for a mobile device and used to power the mobile device.

### Example 5

### Use of Aluminum-Air Battery

A primary aluminum-air battery is used to power a hearing aid. An aluminum stub is used as the metal anode. The aluminum is oxidized as the battery is discharged. The battery is configured such that the oxidized aluminum can be replaced with a new aluminum stub to renew the battery.

### Example 6

### Air-Metal Specific Energies

The following table lists the theoretical specific energies that may be obtained for various air-metal chemistries given the choice of the metal:

| | Calculated | Theoretical |
|---|---|---|
| Metal-air | Open Circuit | Specific Energy |
| Pairing | Voltage | (Wh/kg) |
| Li—O₂ | 2.91 | 11,140 |
| Na—O₂ | 1.94 | 2,260 |
| Ca—O₂ | 3.12 | 4,180 |
| Mg—O₂ | 2.93 | 6,462 |
| Zn—O₂ | 1.65 | 1,350 |

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A flexible battery comprising:
a flexible oxygen permeable substrate;
an air cathode in contact with the oxygen permeable substrate;
a flexible electrolyte in contact with the air cathode;
a flexible metal anode in contact with the flexible electrolyte, such that the flexible metal anode is not in contact with the air cathode; and
a plurality of flexible current collectors, wherein at least one flexible current collector is in contact with the air cathode and at least one flexible current collector is in contact with the flexible metal anode.

2. The flexible battery of claim 1, wherein one or more of the substrate, the electrolyte, the cathode, the anode and the current collectors are optically transparent.

3. The flexible battery of claim 1, wherein the substrate comprises one or more of polyorganosiloxanes, polydimethylsiloxane, cellulose acetates, polysulfones, silicone rubbers, polymer foams, and combinations thereof.

4. The flexible battery of claim 1, wherein the substrate has pores of about 50 μm to about 500 μm in size.

5. The flexible battery of claim 1, wherein the air cathode comprises a wire-grid with a wire-diameter equal to or less than about 50 μm.

6. The flexible battery of claim 1, wherein the air cathode comprises a carbon and a metal-oxide catalyst.

7. The flexible battery of claim 6, wherein the metal-oxide catalyst comprises one or more of manganese, cobalt, ruthenium, platinum, silver, a mixture of manganese and cobalt, mesoporous carbon, activated charcoal, carbon black, powdered graphite, and graphene.

8. (canceled)

9. The flexible battery of claim 6, wherein the air cathode comprises a wire-grid comprising wires of the carbon and the catalyst, wherein the wires have a diameter of about 20 μm separated by a half-pitch of about 20 μm.

10. The flexible battery of claim 1, wherein the electrolyte comprises a salt comprising ions of a metal of the metal anode.

11. The flexible battery of claim 1, wherein the metal anode comprises lithium, sodium, potassium, beryllium, magnesium, calcium, aluminum, zinc, iron, titanium, or a combination thereof.

12. The flexible battery of claim 11, wherein the metal anode comprises a wire-grid comprising wires of the metal, wherein the wires have a diameter of equal to or less than about 50 μm, separated by a half-pitch of at least about 50 μm.

13.-15. (canceled)

16. The flexible battery of claim 1, wherein the current collector comprises a metal thin film, a metal oxide thin film, or a slurry immobilized on a flexible substrate.

17.-18. (canceled)

19. The flexible battery of claim 1, further comprising an air filter.

20. The flexible battery of claim 19, wherein the air filter is configured to remove water from atmospheric air.

21. The flexible battery of claim 1, wherein the battery is rechargeable.

22. The flexible battery of claim 1, wherein the battery is not rechargeable.

23. A method of making a flexible battery, the method comprising:
contacting an air cathode with a flexible oxygen permeable substrate;
contacting a flexible electrolyte with the air cathode;
contacting a metal anode with the flexible electrolyte; and
contacting a plurality of flexible current collectors,
wherein at least one current collector is separately in electrical contact with each of the air cathode and the metal anode.

24. The method of claim 23, wherein one or more of the substrate, the electrolyte, the cathode, the anode and the current collectors are optically transparent.

25. The method of claim 23, wherein the substrate comprises one or more of poly(organosiloxane), polydimethylsiloxane, cellulose acetate, polysulfones, silicone rubbers, polymer foams, and combinations thereof.

26.-27. (canceled)

28. The method of claim 23, wherein the air cathode comprises a carbon and a metal-oxide catalyst.

29.-31. (canceled)

32. The method of claim 23, wherein the metal anode comprises lithium, sodium, potassium, beryllium, magnesium, calcium, aluminum, zinc, iron, titanium, or a combination thereof.

33. (canceled)

34. The method of claim 23, wherein the electrolyte comprises a salt comprising ions of a metal of the metal anode.

35.-37. (canceled)

38. The method of claim 23, wherein the current collector comprises a metal thin film, a metal oxide thin film, or a slurry immobilized on a flexible substrate.

39.-42. (canceled)

43. The method of claim 23, further comprising contacting a first flexible current collector with the air cathode and a second collector with the metal anode.

44. The method of claim 43, further comprising stacking in order, the oxygen permeable substrate, a first flexible current collector, the air cathode, the electrolyte, the metal anode, and a second flexible current collector.

45.-46. (canceled)

47. The method of claim 23, further comprising stacking a first polymer ceramic between the air cathode and the electrolyte, and a second polymer ceramic between the electrolyte and the metal anode, wherein the electrolyte is a solid-state material.
